(19) United States
(12) Patent Application Publication
(10) Pub. No.: US 2026/0196770 A1
(43) Pub. Date: Jul. 9, 2026

(54) CONNECTOR WITH AN IMPROVED LIMITING STRUCTURE

(71) Applicant: FOXCONN INTERCONNECT TECHNOLOGY LIMITED, Grand Cayman (KY)

(72) Inventor: YUNG-CHIH HUNG, New Taipei (TW)

(21) Appl. No.: 19/438,945

(22) Filed: Jan. 2, 2026

(30) Foreign Application Priority Data
Jan. 8, 2025 (CN) 202520043126.0

(51) Int. Cl. H01R 13/629; H01R 12/70; H01R 13/05; H01R 13/504; H01R 13/74

(52) U.S. Cl. CPC H01R 13/62927; H01R 12/7005; H01R 13/05; H01R 13/504; H01R 13/743

(57) ABSTRACT

A connector incudes: a body having a through hole opening forwards; a seat disposed on the body and having a passage corresponding with the through hole and a stuck arm protruding in the passage; and a limiting member being movably accommodated within the passage in a front-rear direction and having a limiting portion and a stuck block. The limiting member is movable forwards until the limiting portion protrudes forward beyond the through hole for limiting purposes and the stuck arm engages with the stuck block to secure the limiting member within the passage.

### BACKGROUND OF THE INVENTION

### 1. Field of the Invention

The present invention relates to a connector with an improved limiting structure.

### 2. Description of Related Arts

U.S. Pat. No. 11,152,724 discloses an electrical connector including an insulation body, a seat, and a positioning plug. The seat is disposed on an outer peripheral surface of the insulation body. The seat includes a tunnel defined through the seat to form an inlet and an outlet. The outlet and a front surface of the insulation body face the same side. The seat further includes a slit and one or more first bumps disposed on an inner wall of the slit. The positioning plug includes a sliding block and a rib. The sliding block is movably disposed in the tunnel via the inlet and the rib is movably disposed in the slit. The positioning plug further includes a second bump disposed on a lateral side of the rib facing the first bump. When the sliding block moves to an installation position, the first bump stops the second bump to fix the sliding block at the installation position.

### SUMMARY OF THE INVENTION

An object of the present invention is to provide a connector with an improved limiting structure.

To achieve the above-mentioned object, a connector comprises: a body having a through hole opening forwards; a seat disposed on the body, the seat having a passage corresponding with the through hole and a stuck arm protruding in the passage; and a limiting member being movably accommodated within the passage in a front-rear direction and having a limiting portion and a stuck block; wherein the limiting member is movable forwards until the limiting portion protrudes forward beyond the through hole for limiting purposes and the stuck arm engages with the stuck block to secure the limiting member within the passage.

Other advantages and novel features of the invention will become more apparent from the following detailed description of the present embodiment when taken in conjunction with the accompanying drawings.

### BRIEF DESCRIPTION OF DRAWINGS

FIG. 1 is a front and top perspective view of a connector according to a first embodiment of the present application, wherein the limiting structure is in a locked position;

FIG. 2 is another perspective view of the connector in FIG. 1;

FIG. 3 is a front and top perspective view of the connector shown in FIG. 1, wherein the limiting structure is in an un-locked state;

FIG. 4 is another perspective view of the connector in FIG. 3;

FIG. 5 is an exploded perspective view of the connector shown in FIG. 1;

FIG. 6 is another exploded perspective view of the connector in FIG. 5;

FIG. 7 is an exploded perspective view of a connector according to a second embodiment of the present application;

FIG. 8 is a perspective view of a part of the connector in FIG. 2;

FIG. 9 is a partial perspective view of a part of the connector in FIG. 4;

FIG. 10 is a perspective view of the connector in FIG. 3 assembled to a panel of an electronic device, wherein the limiting structure has not been pushed forward; and

FIG. 11 is a perspective view of the connector in FIG. 10 assembled to the panel, wherein the limiting structure has been pushed forward.

### DETAILED DESCRIPTION OF THE PREFERRED EMBODIMENT

Reference will now be made to the drawing figures to describe the preferred embodiment of the present invention in detail.

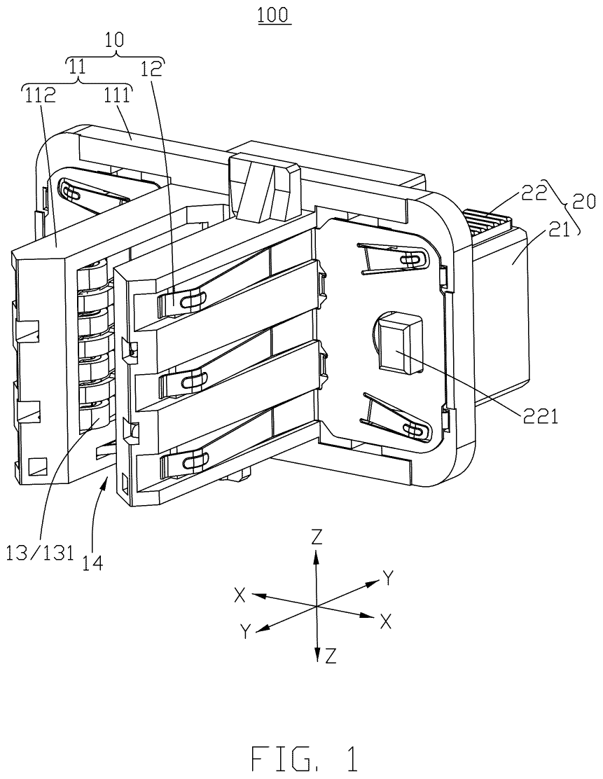

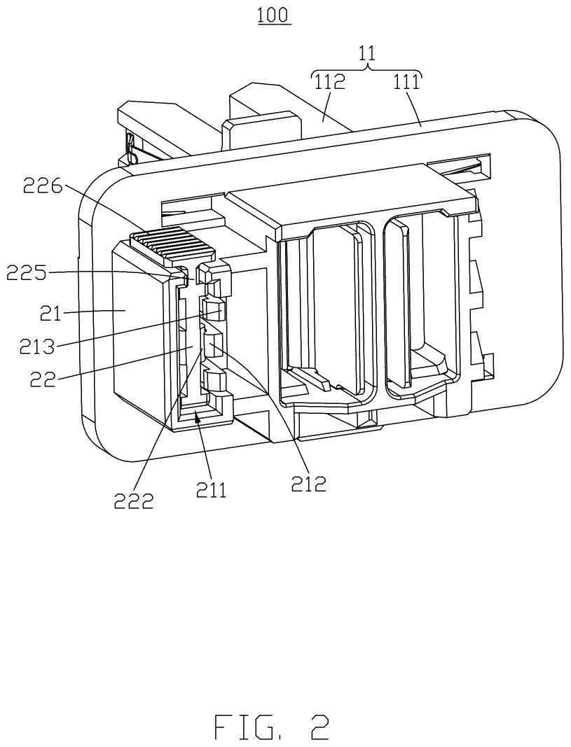

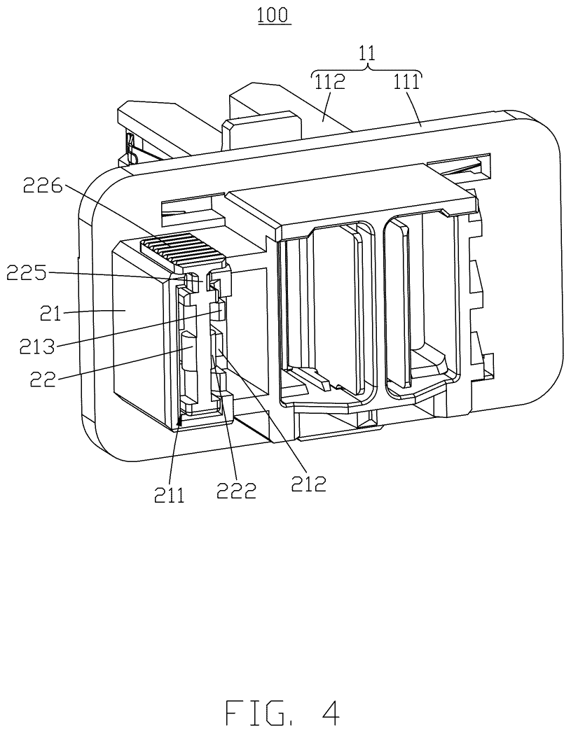

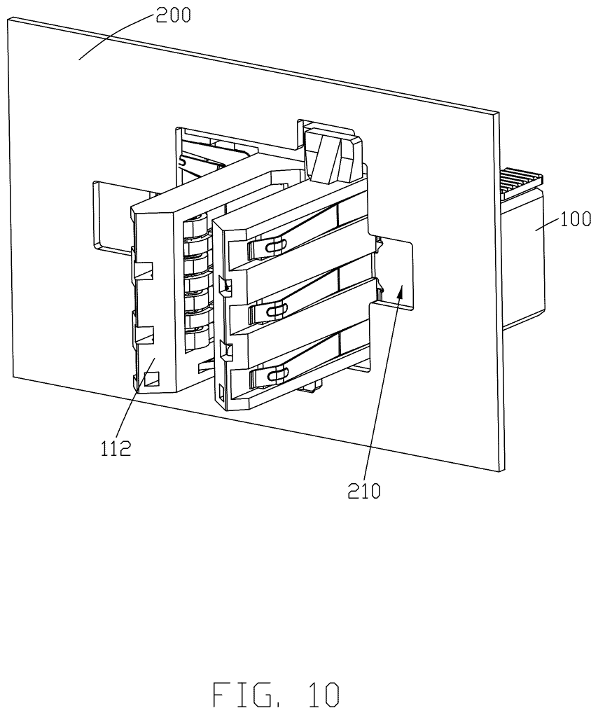

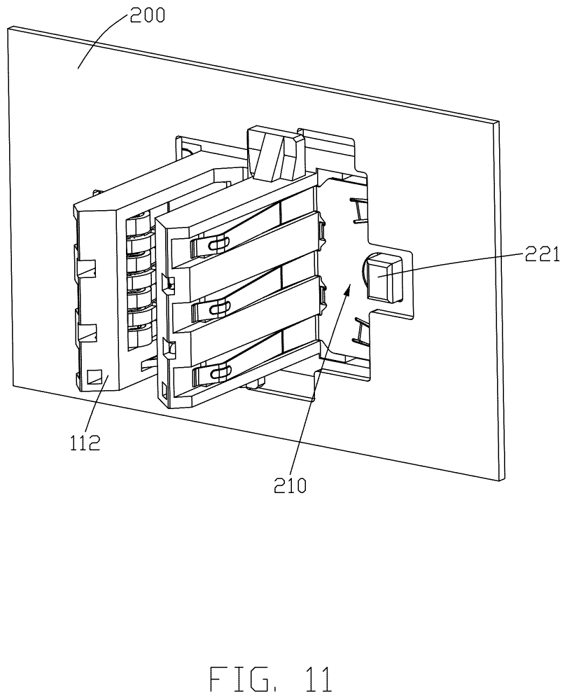

Referring to FIGS. 1 to 4 and FIGS. 10-11, a connector 100 of a first embodiment is illustrated, the connector 100 is used to connect with an electronic component of an electronic device to achieve an electrical connection with the electronic device. In some embodiments, the connector 100 may be an electrical connector transmitting power current and is retained on a panel 200 of the electric device as shown in FIGS. 10-11.

The connector 100 may include a body 10 and a limiting structure 20. The limiting structure 20 is disposed on the body 10 and is used for assembling and positioning the connector 100 on the panel 200 of the electronic device.

In some embodiments, the body 10 may include a supporting portion 11, two conductive elements 12, and power terminals 13.

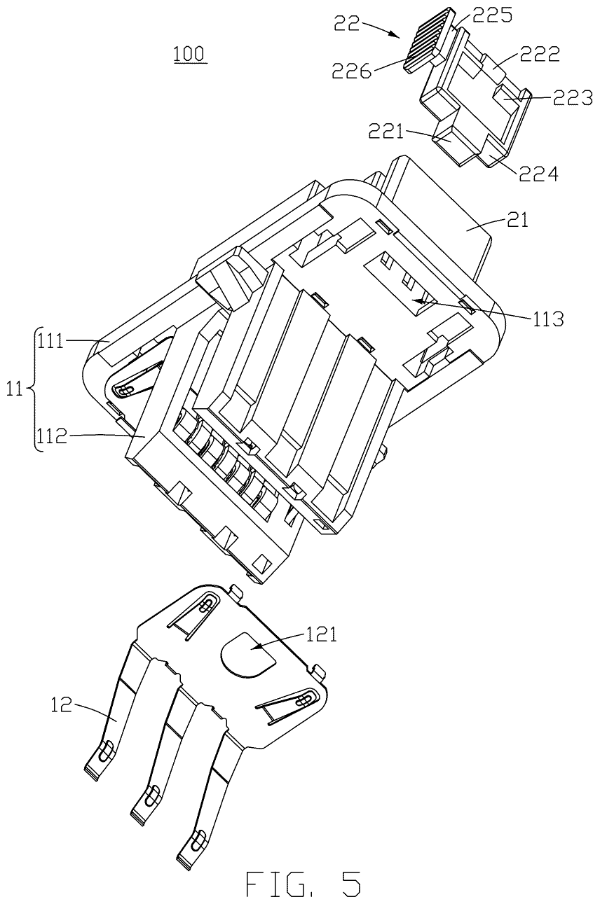

The supporting portion 11 may include a flat portion 111 and a mating portion 112. The flat portion 111 has a through hole 113 as shown in FIG. 5, and the through hole 113 opens forward through the flat portion 111. The mating portion 112 protrudes forward from the flat portion 111 in a mating direction Y-Y of the connector and is used to mate with another electronic device, the flat portion 111 is used to be attached on the panel 200 to retain the connector 100 on the panel.

In some embodiment, the conductive elements 12 are disposed on outsides of the flat portion 111 and the mating portion 112 to achieve a grounding path. The conductive element 12 has an alignment hole 121 corresponding to the through hole 113. The conductive element 12 may be, but is not limited to, a metal sheet for achieving electrical connection.

The power terminals 13 are disposed on the supporting portion 11, and the supporting portion 11 has a mating slot 114. The mating slot 114 opens forward through the mating portion 112 to receive a power plug, like a bus bar. The power terminals 13 are exposed to the mating slot 114 in a first direction X-X, and include contacting portions 131 extending into the mating slot 114 in the first direction X-X.

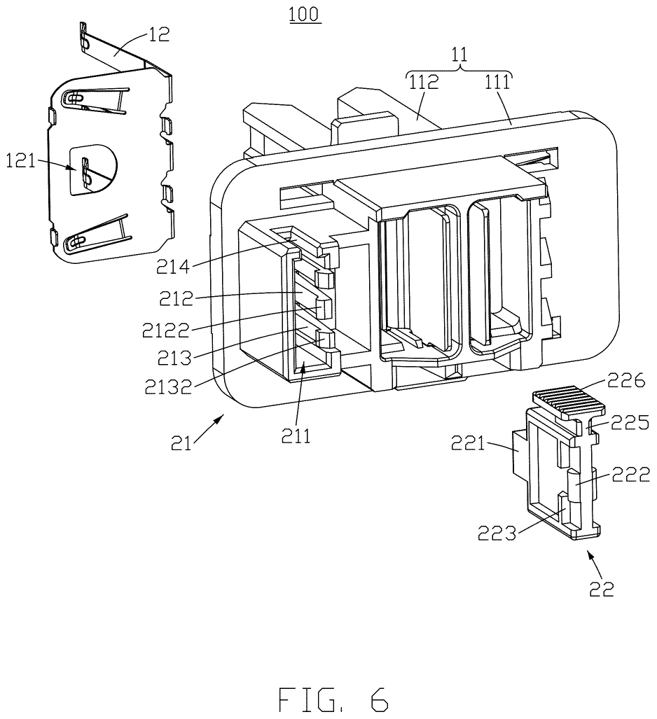

Referring to FIGS. 5 and 6, the limiting structure 20 may include a seat 21 and a limiting member 22.

The seat 21 may be disposed on the flat portion 111 of the supporting portion 11 and aligned with the through hole 113. In some embodiments, the seat 21 may extend from the flat portion 111 away from the mating portion 112 in the mating direction X-X, and the seat 21 may be spaced apart from the mating portion 112. The seat 21 may has a passage 211, at least one stuck arm 212, and at least one positioning arm 213. In this embodiment, the flat portion 111, the mating portion 113 and the seat 21 are united as an insulating housing, the power terminals 13 and conductive elements 12 are disposed on the insulating housing.

The seat 21 is hollow to form the passage 211, and the passage 211 is used for accommodating the limiting member 22.

The stuck arm 212 and the positioning arm 213 are disposed at insides of the passage 211 in the first direction X-X. The stuck arm 212 and the positioning arm 213 are arranged with a gap therebetween in a second direction Z-Z. The stuck arm 212 is used to secure the limiting member 22, thereby ensuring that the limiting member 22 is stably held within the passage 211 at different positions. The positioning arm 213 is used to limit or position the limiting member 22, thereby preventing the limiting member 22 from detaching from the passage 211.

In some embodiments, the stuck arm 212 and the positioning arm 213 are elastic arms. When the stuck arms 212 and/or the positioning arms 213 press against the limiting member 22, they can undergo elastic deformation and have elastic restoring force. In some embodiments, the seat 21 may include one stuck arm 212 and two positioning arms 213. The stuck arm 212 and the two positioning arms 213 are arranged at a same inside of the passage 211. The stuck arm 212 is positioned between the two positioning arms 213 in the second direction Z-Z. In other embodiments, the seat 21 may include more stuck arms 212 and more positioning arms 213, which are distributed on opposite insides of the passage 211, so as to allow the limiting member 22 to be secured and positioned.

The stuck arm 212 has an arc protrusion 2122 at a free end thereof. The arc protrusion 2122 protrudes toward the passage 211 and is used to secure the limiting member 22.

The positioning arm 213 has a hook 2132 at a free end thereof. The hook 2132 protrudes toward the passage 211 and is used to limit or position the limiting member 22.

The limiting member 22 may include a limiting portion 221, at least one stuck block 222, and at least one positioning block 223.

The limiting portion 221 is disposed at a front end of the limiting member 22. The limiting member 22 further has a stop face 224 as shown in FIG. 5, the limiting portion 221 protrudes forwards from the stop face 224. It can be understood that the stop face 224 may be a front face of the limiting member 22, and the limiting portion 221 protrudes from the stop face 224. The limiting portion 221 is configured to be movably aligned with the through hole 113 and is used to limit the panel 200.

The limiting member 22 has the stuck block 222 and the positioning block 223 at the rear end of the limiting member 22 opposite to the limiting portion 221 on the front end. The stuck block 222 and the positioning block 223 are arranged adjacently with a gap in the second direction Z-Z. The stuck block 222 is used to engage with the stuck arm 212, thereby ensuring that the limiting member 22 is stably secured within the passage 211. The positioning block 223 is used to engage with the positioning arm 213, to limit or position the limiting member 22 and prevent the limiting member 22 from detaching from the passage 211.

In some embodiments, the limiting member 22 may include one stuck block 222 and two positioning blocks 223. The stuck block 222 and the two positioning blocks 223 are spaced apart in the second direction Z-Z and disposed at the rear end of the limiting member 22, the stuck block 222 is positioned between the two positioning blocks 223 in the second direction Z-Z. In other embodiments, the limiting member 22 may include more stuck blocks 222 and more positioning blocks 223, which are distributed on opposite surfaces of the limiting member 22. These can engage with the stuck arms 212 and positioning arms 213 from both sides. The stuck block 222 and the two positioning blocks 223 are arranged in an offset manner in the mating direction Y-Y as shown in FIG. 5, the stuck block 222 is positioned closer to the rear end of the limiting member 22 compared to the two positioning blocks 223. The two positioning blocks 223 may be arranged in a collinear configuration in the second direction.

In some embodiments, the stuck block 222 is generally arc-shaped with an arc face 2221 and protrudes outward, allowing for a smooth transition with the arc protrusion 2122 of the stuck arm 212, thereby facilitating the locking and releasing of the stuck block 222 with the stuck arm 212. The positioning block 223 is generally rectangular in shape with a rear plane 2231 and protrudes outward, the hook 2132 has a front plane 2133, enabling secure engagement with the hook 2132 of the positioning arm 213, thereby facilitating the limiting or positioning of the positioning block 223 with the stuck arm 212.

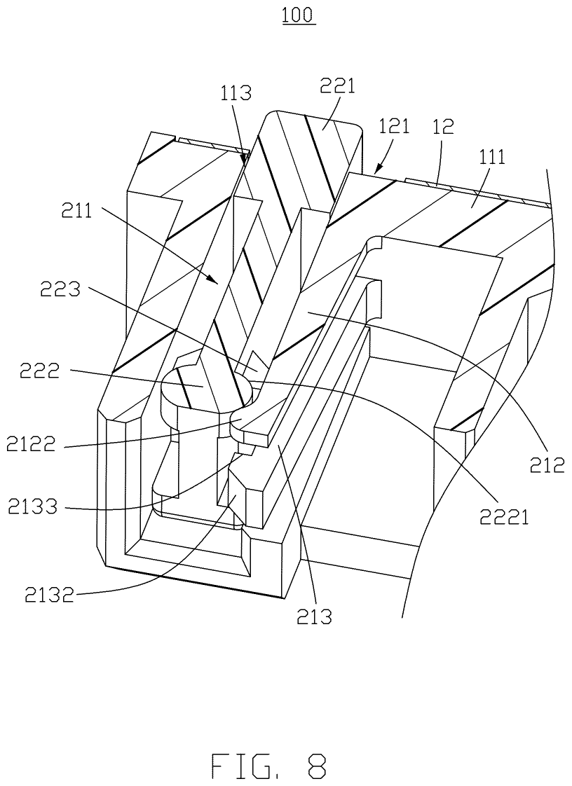

In some embodiments, as shown in FIGS. 1, 2, and 8, when the stop face 224 press against the flat portion 111, the limiting portion 221 protrudes forward beyond the through hole 113, and the arc protrusion 2122 of the stuck arm 212 presses against the stuck block 222, securing the limiting member 22 within the passage 211. At this time, the limiting member 22 and the seat 21 can be in a first/limiting state.

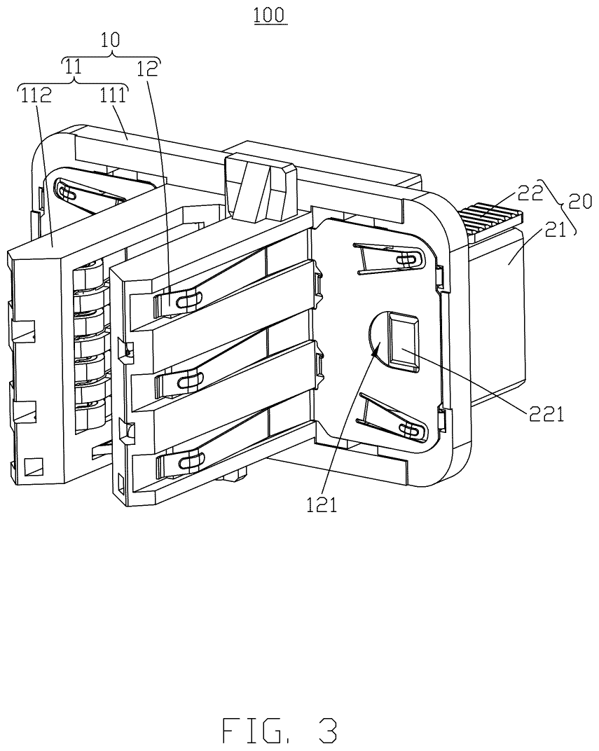

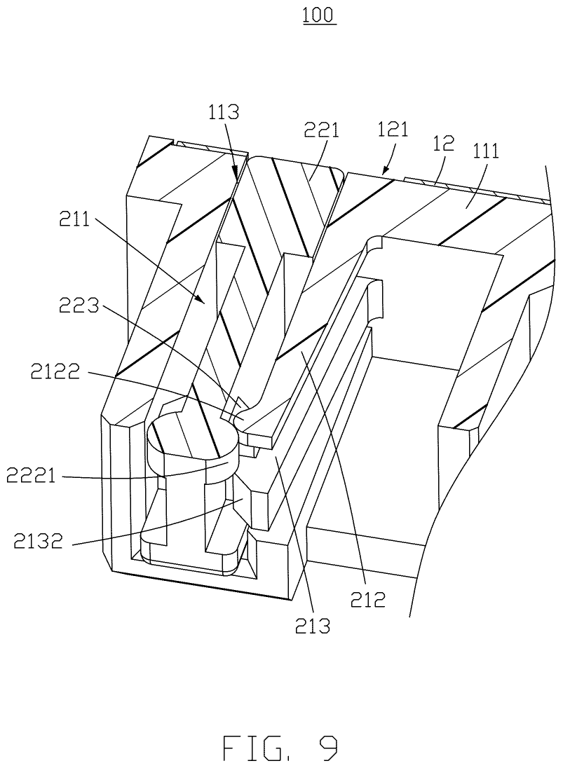

As shown in FIGS. 3, 4, and 9, the limiting portion 221 is hidden in the through hole 113, the arc protrusion 2122 of the stuck arm 212 is located behind the arc protrusion 2122 to release the stuck block 222, and the positioning blocks 223 engages with the hooks 2132 of the positioning arms 213 to prevent the limiting member from detaching from the passage 211. At this time, the limiting member 22 and the seat 21 is in a second/un-locked position.

In some embodiments, the seat 21 may further has at least one slit 214 as best shown in FIG. 6. The slit 214 is formed on at least one side of the seat 21 and communicates with the passage 211. The limiting member 22 may further include at least one rib 225 and at least one push block 226. The rib 225 and the push block 226 are connected and disposed on at least one side of the limiting member 22. The rib 225 passes through the slit 214, and the push block 226 protrudes from the slit 214, i.e., extends outward from at least one side of the seat 21. The push block 226 is used to drive the rib 225 to move within the slit 214, thereby driving the limiting member 22 to move within the passage 211 in the mating direction.

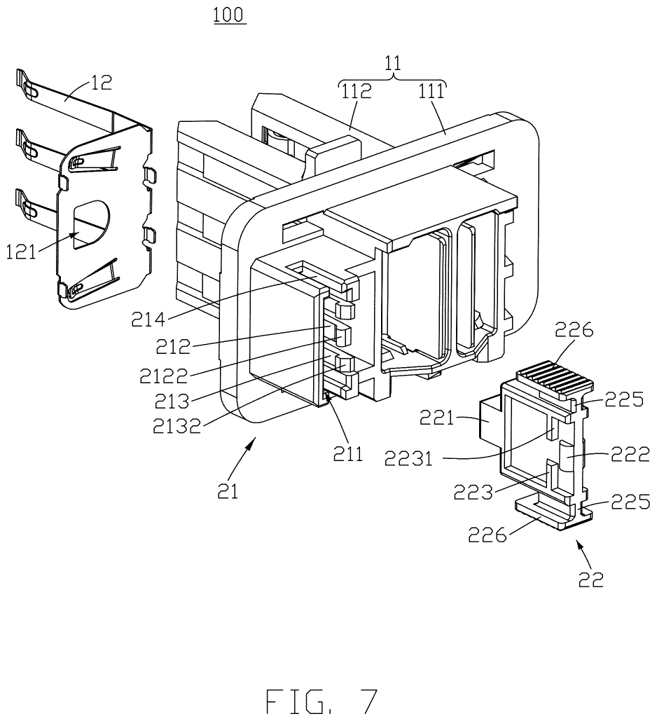

Referring to FIG. 7 illustrating a second embodiments, the seat 21 may include two slits 214 at a top side and a lower side thereof respectively and communicating with the passage 211. The limiting member 22 may include two ribs 225 and two push blocks 226. The two ribs 225 are respectively connected to the corresponding two push blocks 226 and are disposed on opposite sides of the limiting member 22. The two ribs 225 respectively pass through the two slits 214, and the two push blocks 226 respectively protrude from the two slits 214, i.e., extend outward from opposite sides of the seat 21. The two push blocks 226 are used to simultaneously drive the two ribs 225 to move within the two slits 214, thereby jointly driving the limiting member 22 to move within the passage 211.

Referring to FIGS. 5, 6, 8, and 9, during an assembly of the limiting structure 20 into the passage 211, since the seat 21 is formed on the body 10, it is only necessary to assemble the limiting member 22 into the seat 21. The limiting member 22 is inserted into the passage 211, until the limiting portion 221 is inserted into the through hole 113 and the hooks 2132 engage with the rear faces of the positioning blocks. The limiting member 22 can move within the passage 211 in the passage 211 in the mating direction Y-Y. The limiting member can move toward the through hole 113 and the stuck block 222 slides over the arc protrusion 2122 of the stuck arm 212, until the stop face 224 presses against the flat portion 111 of the body 10. At this point, the limiting portion 221 protrudes forward beyond the flat portion 111, and the stuck arms 212 press rearward against a front face of the stuck block 222, thereby securely holding the limiting member 22 in the locking position. The user operates on the push block 226 to push the limiting member 22 to move rearwards in the passage 211.

Referring to FIGS. 5, 6, and 8-11, during the connector 100 is assembled to an assembling hole 210 of the panel 200 of a server, the mating portion 112 is inserted through the assembly hole 210, and the flat portion 111 and the conductive element 12 press against the panel 200. At this point, the limiting portion 221 protruding from the through hole 113 also presses against the panel 200. Due to the force generated by the panel 200 pressing against the limiting portion 221, the limiting portion 221 moves within the passage 211 away from the through hole 113 until the positioning block 223 engages with the positioning arm 213. At this point, the limiting portion 221 is hidden within the through hole 113. During this process, the stuck block 222 slides rearwards over the arc protrusion 2122 of the stuck arm 212, causing the stuck arm 212 to release the limiting member 22. In some embodiment, the limiting member 22 can be move to the un-limiting position by the push blocks 226, and then the connector is located to the panel 200.

Next, the connector 100 moves along a surface of the panel 200 in the first direction X-X, allowing the limiting portion 221 moves to the assembly hole 210. The limiting member is pushed to move forwards by the push block 226, the limiting portion 221 protrudes forwards beyond the panel 200 through the through hole 113, the alignment hole 121, and the assembly hole 210. As a result, the limiting portion 221 can limit the panel 200, restricting a relative movement between the connector 100 and the panel 200. The push block 226 drives the rib 225 to move within the slit 214, thereby driving the limiting member 22 to move toward the through hole 113 until the stop face 224 presses against the flat portion 111 of the body 10. The stuck block 222 slides over the arc protrusion 2122 of the stuck arm 212 and engages with the arc protrusion 2122, thereby securely holding the limiting member 22 within the seat 21.

The limiting member 22 is movably accommodated within the passage 211 and is secured by the engagement between the stuck block 222 and the stuck arm 212, ensuring that the limiting member 22 is stably held within the passage 211. The limiting portion 221 corresponds to and protrudes through the through hole 113 and is used to limit the connector in the panel of the electronic device. By releasing the stuck block 222 from the stuck arm 212, the limiting member 22 can extend out of the passage 211, and the limiting portion 221 is accommodated within the through hole 113, thereby releasing the limiting function. Therefore, it facilitates the convenient assembly and positioning of the connector 100 with the panel 200.

The above-mentioned embodiments are only preferred embodiments of the present invention, and should not limit the scope of the present invention, any simple equivalent changes and modifications made according to the claims of the present invention and the contents of the description should still belong to the present invention.

1. A connector comprising:
a body having a through hole opening forwards;
a seat disposed on the body, the seat having a passage corresponding with the through hole and a stuck arm protruding in the passage; and
a limiting member being movably accommodated within the passage in a front-rear direction and having a limiting portion and a stuck block;
wherein the limiting member is movable forwards until the limiting portion protrudes forward beyond the through hole for limiting purposes and the stuck arm engages with the stuck block to secure the limiting member within the passage.

2. The connector as claimed in claim 1, wherein the seat has two positioning arms protruding in the passage, the limiting member has two positioning blocks, and the positioning arms engage with corresponding positioning blocks when the limiting member moves rearward to avoid the limiting member from detaching from the passage.

3. The connector as claimed in claim 2, wherein the stuck arm has an arc protrusion at a rear end thereof, and the stuck block is arc-shaped for the arc protrusion to smoothly slide over the stuck block.

4. The connector as claimed in claim 3, wherein each of the positioning arms has a hook at a rear end thereof, each of the positioning blocks has a rear plane, and the hooks engage with corresponding rear plane.

5. The connector as claimed in claim 4, wherein the stuck block is located between the two positioning blocks in an upper-lower direction, and the two positioning blocks are located in front of the stuck block in the front-rear direction.

6. The connector as claimed in claim 4, wherein the seat has a slot, the limiting member has a rib and a pushing block, the rib runs through the slot, the push block is located at an outside of the seat, and the push portion is operated by a used to push the limit member to move in the passage.

7. The connector as claimed in claim 4, wherein the seat has two slots at opposite sides thereof in the upper-lower direction, the limiting member has two ribs and two pushing blocks, the ribs run through corresponding slots, the push blocks are located at an outside of the seat, and the push portions are operable to push the limit member to move in the passage.

8. The connector as claimed in claim 4, wherein the limiting member has a stop face and the limiting portion protrudes forwards from the stop face.

9. A connector comprising:
an insulating housing comprising a flat portion with a through hole opening forwards, a mating portion extending forwards from the flat portion and having a mating slot, and a seat extending rearward from the flat portion and having a passage corresponding to the through hole;
power terminals located in the insulating housing and exposed to the mating slot; and
a limiting member having a limiting portion extending forwards and accommodated within the passage, the limiting member being movable between a locking position protruding beyond the flat portion across the through hole and an un-locking position hidden in the through hole; wherein
the seat has a stuck arm and a positioning arm, and the limiting member has a stuck block and a positioning block;
the positioning arm engages with the positioning block to prevent the limiting member from detaching from the passage when the limiting member is in the un-locking position; and
the stuck arm smoothly slides forwards over the stuck block for the limiting member to come to the locking position and then presses rearwards against the stuck block.

10. The connector as claimed in claim 9, wherein the stuck arm has an arc protrusion at a rear end thereof, and the stuck block has an arc face to engage with the arc protrusion.

11. The connector as claimed in claim 10, wherein the positioning arm has a hook at a rear end thereof, the positioning block has a rear plane, and the hook has a front plane to engage with the rear plane of the positioning block when the limiting member is located in the un-lock position.

12. The connector as claimed in claim 9, wherein the stuck arm and the positioning arm are located at an upper-lower side of the passage.

13. The connector as claimed in claim 9, wherein the limiting member has opposite side faces uprightly extending from a front face thereof, each of the side faces has the stuck block and the positioning block, and the stuck arm and the positioning arm are located at an upper-lower side of the passage.
